(19) United States
(12) Patent Application Publication
(10) Pub. No.: US 2017/0373785 A1
(43) Pub. Date: Dec. 28, 2017

(54) RECEIVING DEVICE AND LOCAL LIGHT CONTROL METHOD

(71) Applicant: FUJITSU LIMITED, Kawasaki-shi (JP)

(72) Inventor: Yuki Endo, Kawasaki (JP)

(73) Assignee: FUJITSU LIMITED, Kawasaki-shi (JP)

(21) Appl. No.: 15/588,153

(22) Filed: May 5, 2017

(30) Foreign Application Priority Data
Jun. 27, 2016 (JP) 2016-127025

(51) Int. Cl. H04J 14/02; H04B 10/61; H04B 10/079; H04L 1/20; H04L 1/00

(52) U.S. Cl. CPC H04J 14/0221; H04L 1/203; H04L 1/0045; H04B 10/07953; H04B 10/616; H04J 14/0227

(57) ABSTRACT

A receiving device includes a light source, a wave multiplexer, a converter, a demodulator and a processor. The light source outputs local light. The wave multiplexer causes the local light to interfere with a received signal to acquire an optical signal. The converter converts the optical signal into an electrical signal. The demodulator demodulates the electrical signal to acquire a demodulated signal. The processor is configured to correct an error of the demodulated signal. The processor is configured to acquire a signal correction amount and/or an error rate. The processor is configured to control the light source in order to adjust an output intensity of the local light based on the signal correction amount and/or the error rate.

### CROSS-REFERENCE TO RELATED APPLICATION

This application is based upon and claims the benefit of priority of the prior Japanese Patent Application No. 2016-127025, filed on Jun. 27, 2016, the entire contents of which are incorporated herein by reference.

### FIELD

The embodiments discussed herein are related to a receiving device and a local light control method.

### BACKGROUND

There are recently known 40 Gbps/100 Gbps optical transmission systems that include a digital coherent receiving device employing a DP-QPSK (Dual Polarization-Quadrature Phase Shift Keying) modulation method, for example.

The receiving device acquires a main light signal by causing local light (locally-generated light) to interfere with a received signal, and performs digital signal processing on the acquired main light signal. When performing the digital signal processing, the receiving device adjusts the power of the main light signal so as to obtain a gain satisfying the performance requirement of the main light signal in accordance with the resolving power of an analog/digital converter (ADC). Moreover, the receiving device is designed in consideration of device environment, a span loss on a transmission line, and the like in order to maintain the steady output power of local light used for coherent reception.

Patent Literature 1: Japanese Laid-open Patent Publication No. 2010-245772

Patent Literature 2: Japanese Laid-open Patent Publication No. 2014-123905

Patent Literature 3: Japanese Laid-open Patent Publication No. 2014-168176

For example, when a span loss on a transmission line is small, because the receiving device can perform demodulation by using only the power of a main light signal, the receiving device can perform communication in some cases even if the output power of local light is lowered.

However, in the receiving device, because the output power of local light is constantly output even when communication can be performed after the output power of local light is lowered, the output power of local light becomes excessive and thus power consumption used for local light is wasted.

### SUMMARY

According to an aspect of an embodiment, a receiving device includes a light source, a wave multiplexer, a converter, a demodulator and a processor. The light source outputs local light. The wave multiplexer causes the local light to interfere with a received signal to acquire an optical signal. The converter converts the optical signal into an electrical signal. The demodulator demodulates the electrical signal to acquire a demodulated signal. The processor is configured to correct an error of the demodulated signal. The processor is configured to acquire a signal correction amount and/or an error rate. The processor is configured to control the light source in order to adjust an output intensity of the local light based on the signal correction amount and/or the error rate.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a hardware configuration example of a receiving device according to embodiments;

FIG. 2 is a block diagram illustrating a functional configuration example of a receiving device according to a first embodiment;

FIG. 3 is a diagram explaining an example of a correspondence relationship between the number of correction bits and the reception power of a main light signal that are associated with variations in the output power of local light;

FIG. 4 is a flowchart illustrating an example of processing operations of a controller in the receiving device that are associated with a first local light control process;

FIG. 5 is a block diagram illustrating a functional configuration example of a receiving device according to a second embodiment;

FIG. 6 is a flowchart illustrating an example of processing operations of a controller in the receiving device that are associated with a second local light control process;

FIG. 7 is a block diagram illustrating a functional configuration example of a receiving device according to a third embodiment;

FIG. 8 is a flowchart illustrating an example of processing operations of a controller in the receiving device that are associated with a third local light control process;

FIG. 9 is a block diagram illustrating a functional configuration example of a receiving device according to a fourth embodiment;

FIG. 10 is a flowchart illustrating an example of processing operations of a controller in the receiving device that are associated with a fourth local light control process;

FIG. 11 is a block diagram illustrating a functional configuration example of a receiving device according to a fifth embodiment; and

FIGS. 12 and 13 are flowcharts illustrating an example of processing operations of a controller in the receiving device that are associated with a fifth local light control process.

### DESCRIPTION OF EMBODIMENTS

Preferred embodiments of the present invention will be explained with reference to accompanying drawings. The disclosed technology is not limited to the embodiments explained below. The embodiments explained below may be appropriately combined within a scope in which the combined embodiments do not contradict each other.

### [a] First Embodiment

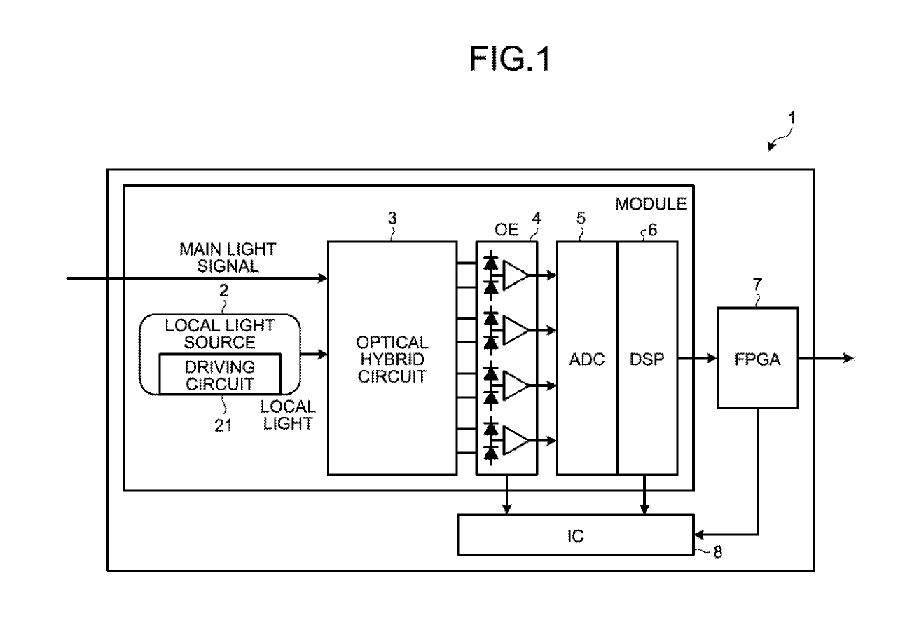

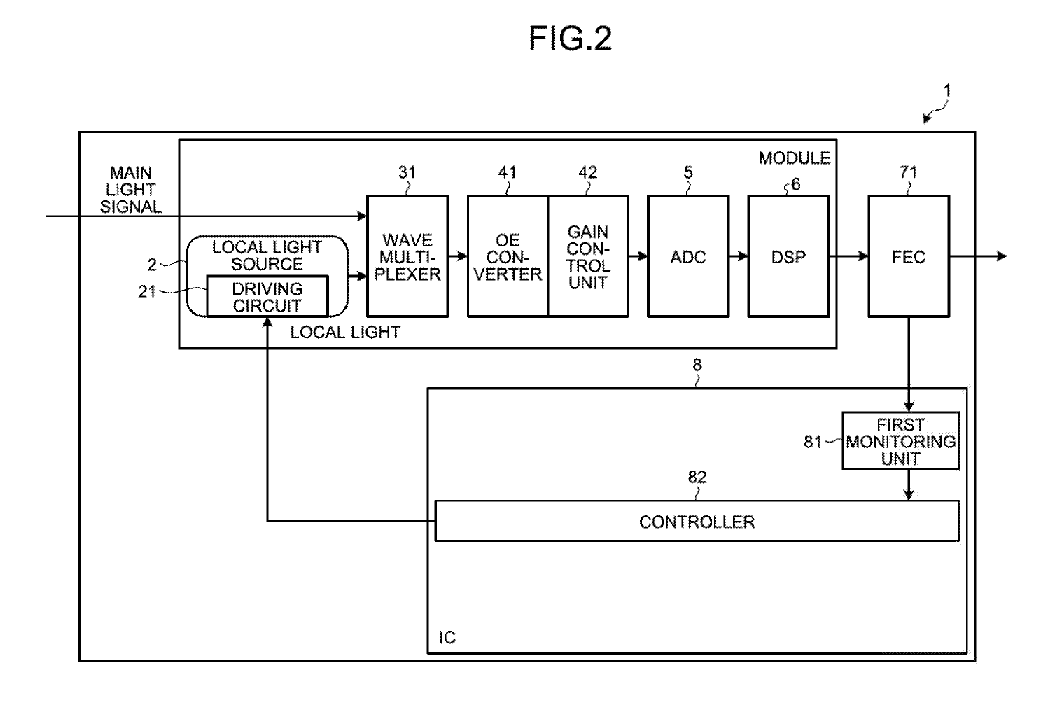

FIG. 1 is a block diagram illustrating a hardware configuration example of a receiving device 1 according to embodiments. FIG. 2 is a diagram explaining a functional configuration example of the receiving device 1 according to the first embodiment. The receiving device 1 illustrated in FIG. 1 is, for example, a digital-coherent light receiving device. The receiving device 1 includes a local light source 2, an optical hybrid circuit 3, an OE (Optical/Electrical converter) 4, an ADC (Analog/Digital Converter) 5, and a DSP (Digital Signal Processor) 6. The receiving device 1 further includes a field programmable gate array (FPGA) 7 and an integrated circuit (IC) 8. Moreover, the local light source 2, the optical hybrid circuit 3, the OE 4, the ADC 5, and the DSP 6 have a module configuration, for example. The local light source 2 includes, for example, a laser (not illustrated) that is a light source for emitting local light and a driving circuit 21 that controls the drive of the laser.

The optical hybrid circuit 3 includes a wave multiplexer 31. The wave multiplexer 31 causes local light to interfere with a received signal to acquire a main light signal. For example, the wave multiplexer 31 mixes a received signal with local light without delaying the phase of the local light to obtain an X-polarized and Y-polarized I-component main light signal. Moreover, the wave multiplexer 31 delays the phase of local light and mixes the received signal and the local light to obtain an X-polarized and Y-polarized Q-component main light signal.

The OE 4 performs electric conversion of the X-polarized and Y-polarized I-component main light signal to adjust a gain and also performs electric conversion of the X-polarized and Y-polarized Q-component main light signal to adjust a gain. The OE 4 includes an OE converter 41 and a gain control unit 42, for example. The OE converter 41 is a converter that performs electric conversion of the X-polarized and Y-polarized I-component main light signal from the optical hybrid circuit 3 and also performs electric conversion of the X-polarized and Y-polarized Q-component main light signal from the optical hybrid circuit 3. The gain control unit 42 adjusts gains of an X-polarized and Y-polarized I-component electrical signal and an X-polarized and Y-polarized Q-component electrical signal that are electrically converted by the OE converter 41.

The ADC 5 performs digital conversion on the gain-adjusted I-component and Q-component electrical signals. The DSP 6 is a demodulator that performs digital signal processing on the digitally-converted I-component and Q-component electrical signals to demodulate the I-component and Q-component electrical signals into a demodulated signal. The FPGA 7 includes an FEC (Forward Error Correction) 71, for example. The FEC 71 is a correction unit that performs an FEC process on the demodulated signal. The IC 8 controls the whole of the receiving device 1. The IC 8 includes a first monitoring unit 81 and a controller 82. The first monitoring unit 81 acquires the number of correction bits and/or an error rate of the demodulated signal from the FEC 71. The controller 82 controls the whole of the IC 8.

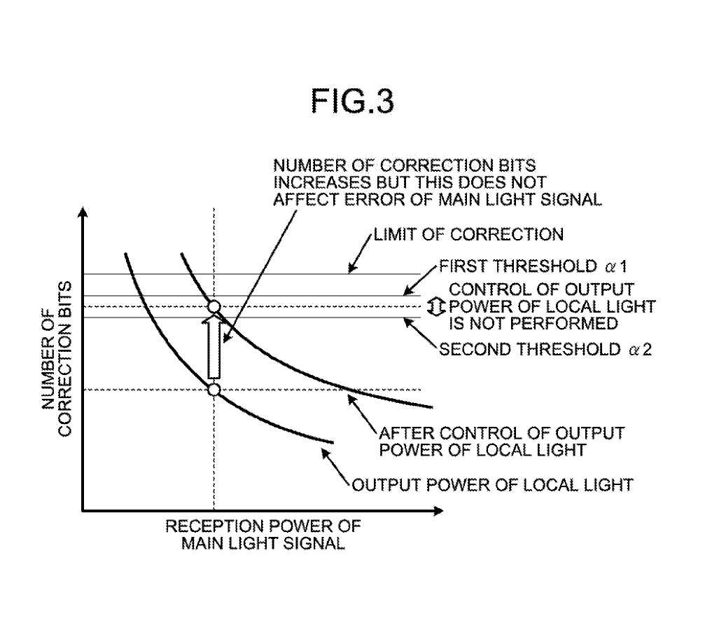

FIG. 3 is a diagram explaining an example of a correspondence relationship between the number of correction bits and the reception power of a main light signal that are associated with variations in the output power of local light. A first threshold α1 is the number of correction bits and/or an error rate corresponding to an upper limit of an allowable range in which the signal quality of the main light signal can secure stable signal quality. A second threshold α2 is the number of correction bits and/or an error rate corresponding to a lower limit of the allowable range in which the signal quality of the main light signal can secure stable signal quality. In case of the number of correction bits and/or the error rate in the allowable range between the first threshold α1 and the second threshold α2, the output power of the main light signal is secured in a signal quality margin without adjusting the output power of local light. Moreover, the number of correction bits and/or an error rate are/is increased along with the degradation of the signal quality of the main light signal.

On the contrary, when the number of correction bits and/or the error rate exceed(s) the first threshold α1, the signal quality of the main light signal exceeds the lower limit of the signal quality margin. Therefore, the output power of the main light signal is adjusted to fall within the signal quality margin by increasing the output power of local light. When the number of correction bits and/or the error rate are/is less than the second threshold α2, the signal quality of the main light signal exceeds the upper limit of the signal quality margin. Therefore, it is determined that signal quality is sufficiently secured. Then, the output power of the main light signal is adjusted to fall within the signal quality margin by decreasing the output power of local light.

The first monitoring unit 81 acquires the number of correction bits and/or the error rate with respect to the demodulated signal after demodulation through the FEC 71. When receiving the main light signal, the controller 82 acquires the number of correction bits and/or the error rate of the main light signal from the first monitoring unit 81. When the acquired number of correction bits and/or error rate exceed(s) the first threshold α1, the controller 82 controls the driving circuit 21 of the local light source 2 in order to increase the output power of local light. When the acquired number of correction bits and/or error rate are/is less than the second threshold α2, the controller 82 controls the driving circuit 21 of the local light source 2 in order to decrease the output power of local light.

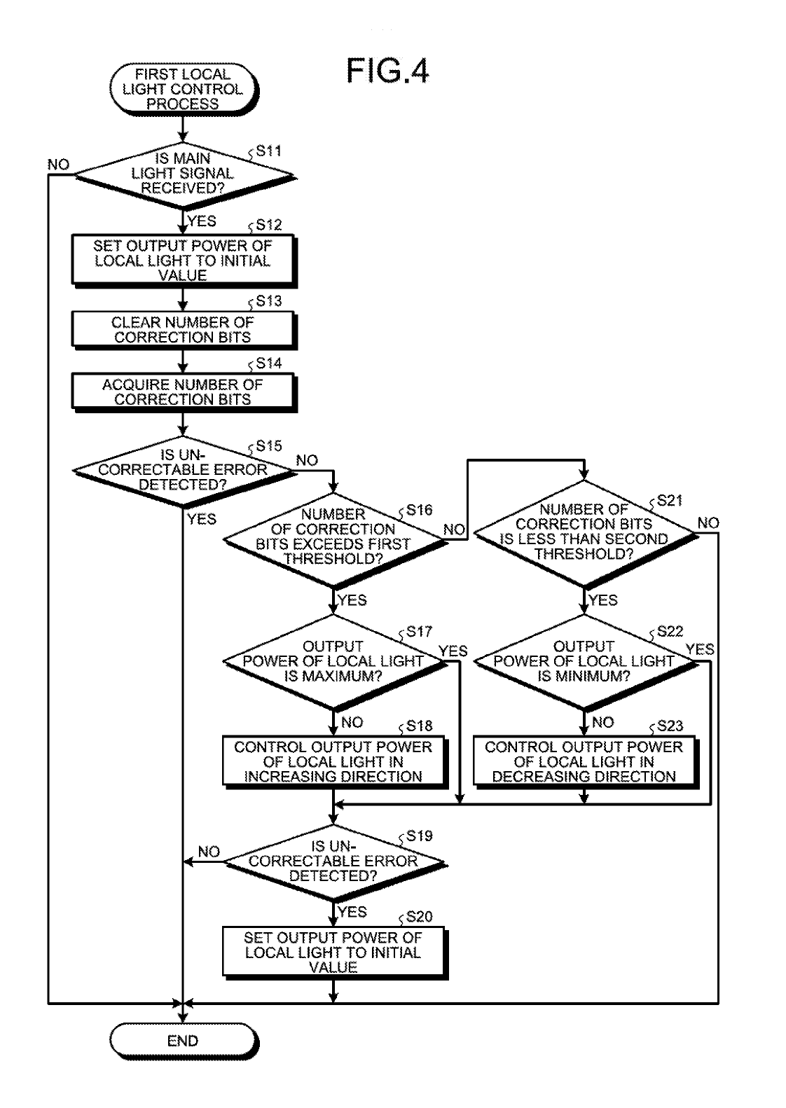

Next, operations of the receiving device 1 according to the first embodiment will be explained. FIG. 4 is a flowchart illustrating an example of processing operations of the controller 82 in the receiving device 1 that are associated with a first local light control process.

The controller 82 determines whether a main light signal is received (Step S11). When receiving the main light signal (Step S11: YES), the controller 82 controls the driving circuit 21 of the local light source 2 in order to set the output power of local light to an initial value (Step S12).

The controller 82 clears the number of correction bits and/or the error rate of the FEC 71 (Step S13), and acquires the number of correction bits and/or an error rate from the FEC 71 through the first monitoring unit 81 (Step S14). The controller 82 determines whether an uncorrectable error is detected from the FEC 71 (Step S15). When the uncorrectable error is detected (Step S15: YES), the controller 82 terminates the processing operations illustrated in FIG. 4.

When the uncorrectable error is not detected (Step S15: NO), the controller 82 determines whether the number of correction bits and/or the error rate acquired in Step S14 exceed(s) the first threshold α1 (Step S16). When the number of correction bits and/or the error rate exceed(s) the first threshold α1 (Step S16: YES), the controller 82 determines whether the output power of local light is the maximum (Step S17).

When the output power of local light is not the maximum (Step S17: NO), the controller 82 controls the driving circuit 21 of the local light source 2 in order to increase the output power of local light (Step S18). In other words, by increasing the output power of local light, the output power of the main light signal falls within the signal quality margin. As a result, the signal quality of the main light signal can be improved. Then, after controlling the driving circuit 21 of the local light source 2, the controller 82 determines whether the uncorrectable error is detected from the FEC 71 (Step S19).

When the uncorrectable error is detected (Step S19: YES), the controller 82 controls the driving circuit 21 of the local light source 2 in order to set the output power of local light to an initial value (Step S20), and terminates the processing operations illustrated in FIG. 4. When the uncorrectable error is not detected (Step S19: NO), the controller 82 terminates the processing operations illustrated in FIG. 4. When the output power of local light is the maximum (Step S17: YES), the controller 82 moves to Step S19 in order to determine whether the uncorrectable error is detected.

When the number of correction bits and/or the error rate do(does) not exceed the first threshold α1 (Step S16: NO), the controller 82 determines whether the number of correction bits and/or the error rate are(is) less than the second threshold α2 (Step S21). When the number of correction bits and/or the error rate are(is) less than the second threshold α2 (Step S21: YES), the controller 82 determines whether the output power of local light is the minimum (Step S22).

When the output power of local light is not the minimum (Step S22: NO), the controller 82 controls the driving circuit 21 of the local light source 2 in order to decrease the output power of local light (Step S23). In other words, by decreasing the output power of local light, the output power of the main light signal falls within the signal quality margin. As a result, while securing the stable signal quality of the main light signal, it is possible to suppress wasteful power consumption used for local light. After controlling the driving circuit 21 of the local light source 2, the controller 82 moves to Step S19 in order to determine whether the uncorrectable error is detected.

When the output power of local light is the minimum (Step S22: YES), the controller 82 moves to Step S19 in order to determine whether the uncorrectable error is detected. When the number of correction bits and/or the error rate are(is) not less than the second threshold α2 (Step S21: NO), the controller 82 terminates the processing operations illustrated in FIG. 4. Moreover, when the main light signal is not received (Step S11: NO), the controller 82 terminates the processing operations illustrated in FIG. 4.

When the number of correction bits and/or the error rate exceed(s) the first threshold α1 and the output power of local light is not the maximum, the controller 82 that performs the first local light control process illustrated in FIG. 4 increases the output power of local light. As a result, the stable signal quality of the main light signal can be secured by causing the output power of the main light signal to fall within the signal quality margin.

When the number of correction bits and/or the error rate are(is) less than the second threshold α2 and the output power of local light is not the minimum, the controller 82 decreases the output power of local light. As a result, by causing the output power of the main light signal to fall within the signal quality margin, it is possible to suppress wasteful power consumption used for local light while securing the stable signal quality of the main light signal.

The receiving device 1 according to the first embodiment controls the driving circuit 21 in order to adjust the output power of local light on the basis of the number of correction bits and/or the error rate acquired by the first monitoring unit 81. For example, when the number of correction bits and/or the error rate are(is) less than the second threshold α2, the receiving device 1 controls the driving circuit 21 in order to decrease the output power of local light. As a result, while securing the stable signal quality of the main light signal, it is possible to suppress wasteful power consumption used for local light.

In particular, because the receiving device 1 uninterruptedly operates 24 hours 365 days, for example, when entering an operating state once, the power consumption has large effects if the wasteful power consumption used for local light is suppressed.

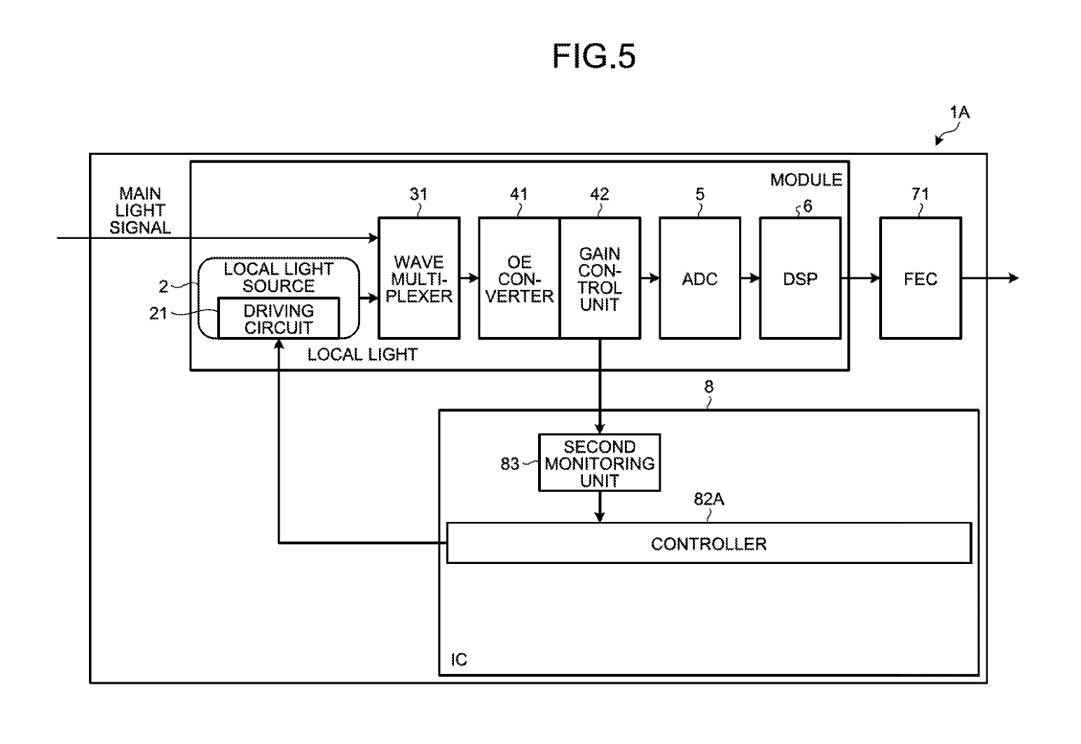

It has been explained that the receiving device 1 of the first embodiment controls the output power of local light on the basis of the number of correction bits and/or the error rate. However, the first embodiment is not limited to the number of correction bits and/or the error rate. For example, the receiving device may control the output power of local light by using a signal amplitude value of a multiplexed signal before the digital conversion. An embodiment for this case will be explained below as a second embodiment. FIG. 5 is a diagram explaining a functional configuration example of a receiving device 1A according to the second embodiment. Moreover, because the same components as those of the receiving device 1 of the first embodiment have the same reference numbers, the explanations of the same configuration and operation are omitted.

### [b] Second Embodiment

A difference between the receiving device 1 and the receiving device 1A illustrated in FIG. 5 is the point that the receiving device 1A embeds therein, instead of the first monitoring unit 81, a second monitoring unit 83 that acquires a signal amplitude value of a multiplexed signal before digital conversion, and adjusts the output power of local light on the basis of the monitoring result of the second monitoring unit 83.

The gain control unit 42 in the receiving device 1A adjusts an amplitude gain of a multiplexed signal that is the main light signal acquired by the wave multiplexer 31 in accordance with the resolving power of the ADC 5. In this case, when a span loss of a transmission line connected to the receiving device 1A is small, for example, because demodulation can be performed with only the output power of the main light signal, communications can be performed in some cases even if the output power of local light is lowered. The second monitoring unit 83 acquires the signal amplitude value of the electrical signal of the multiplexed signal from the gain control unit 42.

When the signal amplitude value of the multiplexed signal before digital conversion is less than a first amplitude threshold and the output power of local light is not the maximum, a controller 82A adjusts the output power of local light in an increasing direction. Moreover, the first amplitude threshold is the minimum signal amplitude value of an allowable range in which the main light signal can secure stable signal quality.

When the signal amplitude value of the multiplexed signal before digital conversion exceeds a second amplitude threshold and the output power of local light is not the minimum, the controller 82A adjusts the output power of local light in a decreasing direction. Moreover, the second amplitude threshold is the maximum signal amplitude value of the allowable range in which the main light signal can secure stable signal quality.

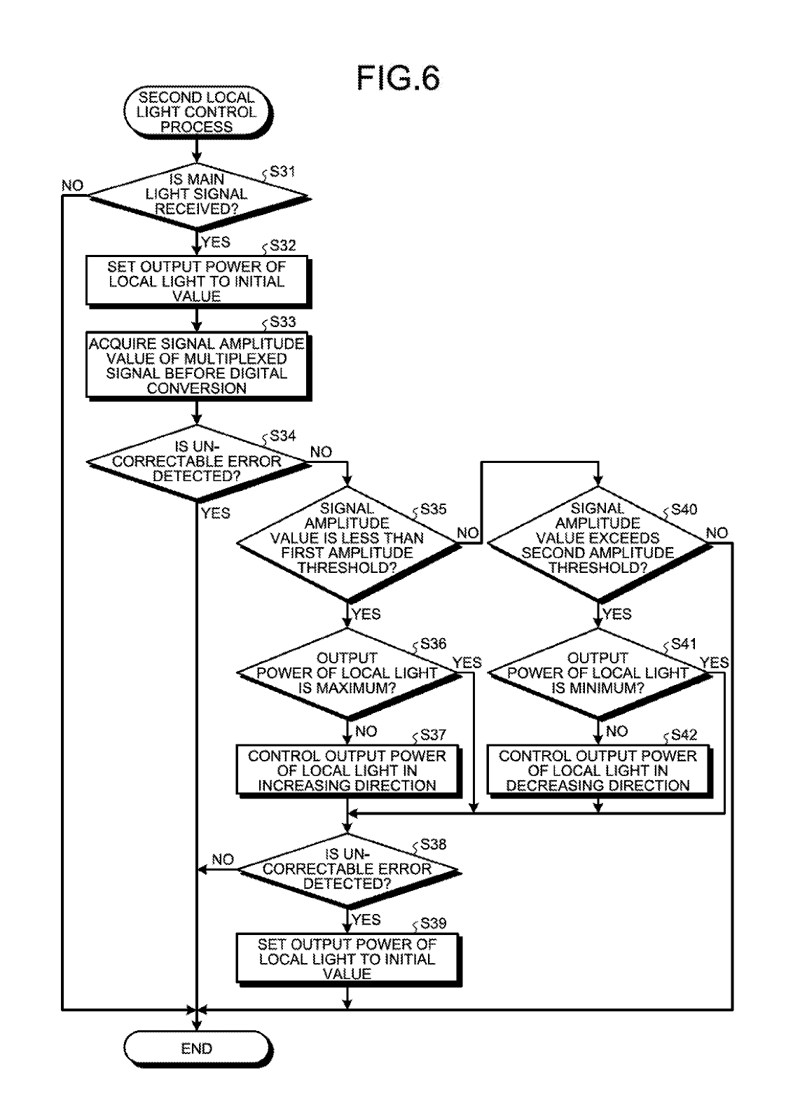

Next, operations of the receiving device 1A according to the second embodiment will be explained. FIG. 6 is a flowchart illustrating an example of processing operations of the controller 82A in the receiving device 1A that are associated with a second local light control process.

The controller 82A determines whether a main light signal is received (Step S31). When receiving the main light signal (Step S31: YES), the controller 82A controls the driving circuit 21 of the local light source 2 in order to set the output power of local light to an initial value (Step S32).

The controller 82A acquires a signal amplitude value of a multiplexed signal before digital conversion through the second monitoring unit 83 (Step S33). The controller 82A determines whether an uncorrectable error is detected from the FEC 71 (Step S34). When the uncorrectable error is detected (Step S34: YES), the controller 82A terminates processing operations illustrated in FIG. 6.

When the uncorrectable error is not detected (Step S34: NO), the controller 82A determines whether the signal amplitude value of the multiplexed signal before digital conversion is less than the first amplitude threshold (Step S35). When the signal amplitude value of the multiplexed signal before digital conversion is less than the first amplitude threshold (Step S35: YES), the controller 82A determines whether the output power of local light is the maximum (Step S36).

When the output power of local light is not the maximum (Step S36: NO), the controller 82A controls the driving circuit 21 of the local light source 2 in order to increase the output power of local light (Step S37). In other words, by increasing the output power of local light, the output power of the main light signal falls within the signal quality margin. As a result, the stable signal quality of the main light signal can be improved. After controlling the driving circuit 21 of the local light source 2, the controller 82A determines whether the uncorrectable error is detected (Step S38). When the uncorrectable error is detected (Step S38 YES), the controller 82A controls the driving circuit 21 of the local light source 2 in order to set the output power of local light to the initial value (Step S39), and terminates processing operations illustrated in FIG. 6. When the uncorrectable error is not detected (Step S38: NO), the controller 82A terminates processing operations illustrated in FIG. 6. When the output power of local light is the maximum (Step S36: YES), the controller 82A moves to Step S38 in order to determine whether the uncorrectable error is detected.

When the signal amplitude value of the multiplexed signal before digital conversion is not less than the first amplitude threshold (Step S35: NO), the controller 82A determines whether the signal amplitude value exceeds the second amplitude threshold (Step S40). When the signal amplitude value exceeds the second amplitude threshold (Step S40: YES), the controller 82A determines whether the output power of local light is the minimum (Step S41).

When the output power of local light is not the minimum (Step S41: NO), the controller 82A controls the driving circuit 21 of the local light source 2 in order to decrease the output power of local light (Step S42). In other words, by decreasing the output power of local light, the output power of the main light signal falls within the signal quality margin. As a result, it is possible to suppress wasteful power consumption used for local light while securing the stable signal quality of the main light signal. After controlling the driving circuit 21 of the local light source 2, the controller 82A moves to Step S38 in order to determine whether the uncorrectable error is detected.

When the output power of local light is the minimum (Step S41: YES), the controller 82A moves to Step S38 in order to determine whether the uncorrectable error is detected. When the signal amplitude value does not exceed the second amplitude threshold (Step S40: NO), the controller 82A terminates processing operations illustrated in FIG. 6. Moreover, when the main light signal is not received (Step S31: NO), the controller 82A terminates processing operations illustrated in FIG. 6.

When the signal amplitude value of the multiplexed signal before digital conversion is less than the first amplitude threshold and the output power of local light is not the maximum, the controller 82A that performs the second local light control process illustrated in FIG. 6 increases the output power of local light. As a result, by causing the output power of the main light signal to fall within the signal quality margin, the stable signal quality of the main light signal can be secured.

When the signal amplitude value of the multiplexed signal before digital conversion exceeds the second amplitude threshold and the output power of local light is not the minimum, the controller 82A decreases the output power of local light. As a result, by causing the output power of the main light signal to fall within the signal quality margin, it is possible to suppress wasteful power consumption used for local light while securing the stable signal quality of the main light signal.

The receiving device 1A according to the second embodiment controls the driving circuit 21 in order to adjust the output power of local light on the basis of the signal amplitude value of the multiplexed signal before digital conversion acquired by the second monitoring unit 83. For example, when the signal amplitude value of the multiplexed signal before digital conversion exceeds the second amplitude threshold, the receiving device 1A controls the driving circuit 21 in order to decrease the output power of local light. As a result, it is possible to suppress wasteful power consumption used for local light while securing the stable signal quality of the main light signal. Furthermore, it is possible to control the output power of local light with high accuracy in accordance with a receiving level of the received main light signal.

It has been explained that the receiving device 1A of the second embodiment controls the output power of local light on the basis of the signal amplitude value of the multiplexed signal before digital conversion. However, the receiving device 1A may control the output power of local light based on the signal amplitude value of the multiplexed signal before digital conversion together with the control of the output power of local light based on the number of correction bits and/or the error rate associated with the receiving device 1 of the first embodiment. In other words, because the output power of local light is previously adjusted by using the signal amplitude value of the multiplexed signal before digital conversion, the adjustment process of the output power of local light can be speedily performed by using the subsequent number of correction bits and/or error rate.

When the control of the output power of local light based on the number of correction bits and/or the error rate is together used, the receiving device 1A may predict the output power of local light from the signal amplitude value of the multiplexed signal before digital conversion. In this case, the receiving device 1A controls the driving circuit 21 in order to adjust the output power of local light on the basis of the prediction result and the number of correction bits and/or the error rate. As a result, the adjustment process of the output power of local light can be speedily performed by using the number of correction bits and/or the error rate.

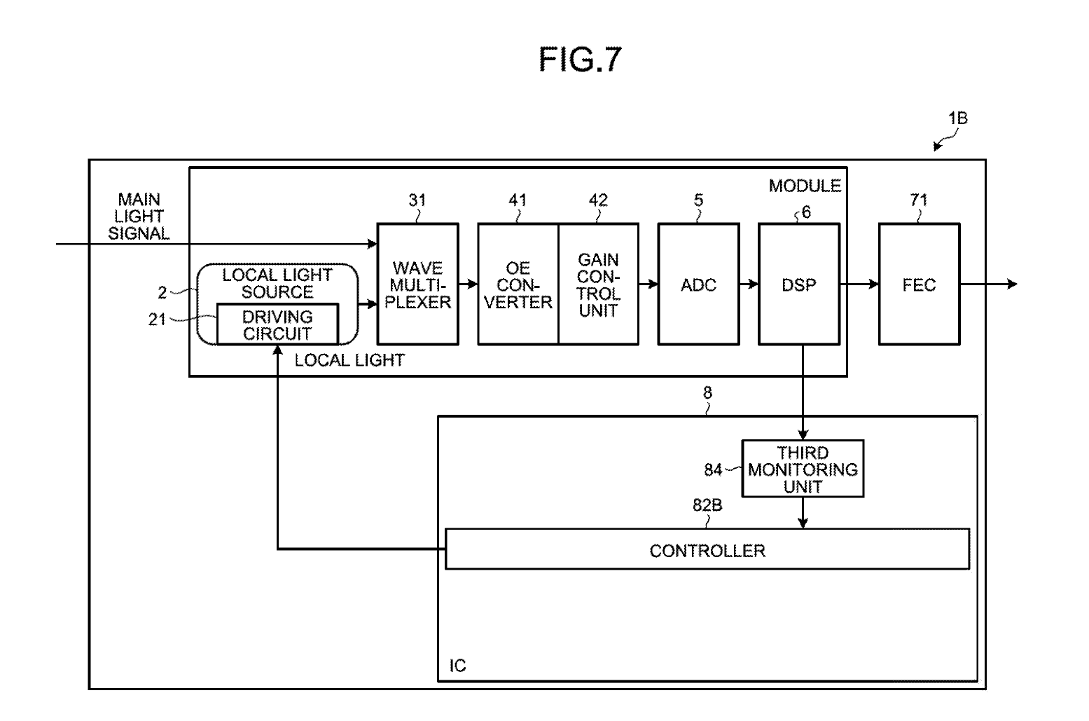

It has been explained that the receiving device 1 of the first embodiment controls the output power of local light on the basis of the number of correction bits and/or the error rate. However, the embodiment is not limited to the number of correction bits and/or the error rate. For example, the output power of local light may be controlled by using a signal amplitude value of a multiplexed signal after digital conversion. An embodiment for this case will be explained below as a third embodiment. FIG. 7 is a diagram explaining a functional configuration example of a receiving device 1B according to the third embodiment. Moreover, because the same components as those of the receiving device 1 of the first embodiment have the same reference numbers, the explanations of the same configuration and operation are omitted.

### [c] Third Embodiment

A difference between the receiving device 1B illustrated in FIG. 7 and the receiving device 1 is the point that the receiving device 1B embeds therein, instead of the first monitoring unit 81, a third monitoring unit 84 that acquires a signal amplitude value of a multiplexed signal after digital conversion, and adjusts the output power of local light on the basis of a monitoring result of the third monitoring unit 84. The third monitoring unit 84 acquires, from the DSP 6, a signal amplitude value of a multiplexed signal after demodulation, namely, a signal amplitude value of a multiplexed signal after digital conversion.

When the signal amplitude value of the multiplexed signal after digital conversion is less than a third amplitude threshold and the output power of local light is not the maximum, a controller 82B adjusts the output power of local light in an increasing direction. Moreover, the third amplitude threshold is the minimum signal amplitude value of an allowable range in which a main light signal can secure stable signal quality.

When the signal amplitude value of the multiplexed signal after digital conversion exceeds a fourth amplitude threshold and the output power of local light is not the minimum, the controller 82B adjusts the output power of local light in a decreasing direction. Moreover, the fourth amplitude threshold is the maximum signal amplitude value of the allowable range in which the main light signal can secure stable signal quality.

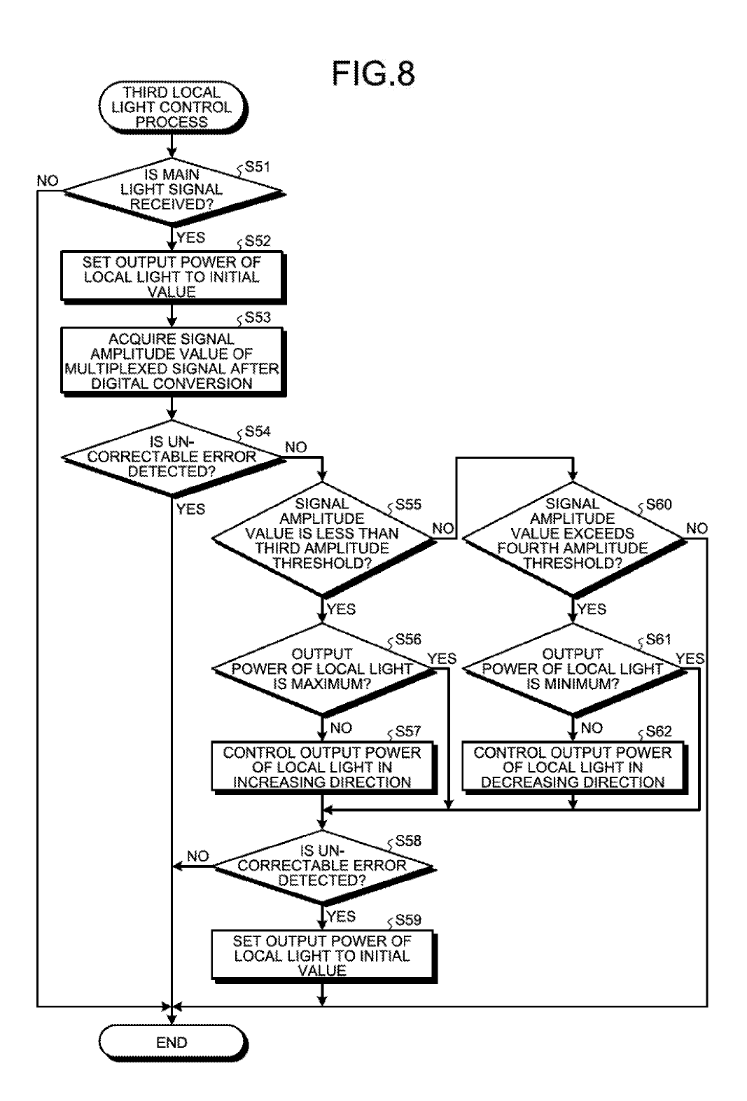

Next, operations of the receiving device according to the third embodiment will be explained. FIG. 8 is a flowchart illustrating an example of processing operations of the controller 82B in the receiving device that are associated with a third local light control process.

The controller 82B determines whether a main light signal is received (Step S51). When receiving the main light signal (Step S51: YES), the controller 82B controls the driving circuit 21 of the local light source 2 in order to set the output power of local light to an initial value (Step S52).

The controller 82B acquires a signal amplitude value of a multiplexed signal after digital conversion through the third monitoring unit 84 (Step S53). The controller 82B determines whether an uncorrectable error is detected from the FEC 71 (Step S54). When the uncorrectable error is detected (Step S54: YES), the controller 82B terminates processing operations illustrated in FIG. 8.

When the uncorrectable error is not detected (Step S54: NO), the controller 82B determines whether the signal amplitude value of the multiplexed signal after digital conversion acquired in Step S53 is less than the third amplitude threshold (Step S55). When the signal amplitude value of the multiplexed signal after digital conversion is less than the third amplitude threshold (Step S55: YES), the controller 82B determines whether the output power of local light is the maximum (Step S56).

When the output power of local light is not the maximum (Step S56: NO), the controller 82B controls the driving circuit 21 of the local light source 2 in order to increase the output power of local light (Step S57). In other words, by increasing the output power of local light, the output power of the main light signal falls within the signal quality margin. As a result, the stable signal quality of the main light signal can be improved. After controlling the driving circuit 21 of the local light source 2, the controller 82B determines whether the uncorrectable error is detected (Step S58).

When the uncorrectable error is detected (Step S58: YES), the controller 82B controls the driving circuit 21 of the local light source 2 in order to set the output power of local light to the initial value (Step S59), and terminates processing operations illustrated in FIG. 8. When the uncorrectable error is not detected (Step S58: NO), the controller 82B terminates processing operations illustrated in FIG. 8. When the output power of local light is the maximum (Step S56: YES), the controller 82B moves to Step S58 in order to determine whether the uncorrectable error is detected.

When the signal amplitude value of the multiplexed signal after digital conversion is not less than the third amplitude threshold (Step S55: NO), the controller 82B determines whether the signal amplitude value of the multiplexed signal after digital conversion exceeds the fourth amplitude threshold (Step S60). When the signal amplitude value of the multiplexed signal after digital conversion exceeds the fourth amplitude threshold (Step S60: YES), the controller 82B determines whether the output power of local light is the minimum (Step S61).

When the output power of local light is not the minimum (Step S61: NO), the controller 82B controls the driving circuit 21 of the local light source 2 in order to decrease the output power of local light (Step S62). In other words, the output power of the main light signal falls within the signal quality margin by decreasing the output power of local light. As a result, it is possible to suppress wasteful power consumption used for local light while securing the stable signal quality of the main light signal. After controlling the driving circuit 21 of the local light source 2, the controller 82B moves to Step S58 in order to determine whether the uncorrectable error is detected.

When the output power of local light is the minimum (Step S61: YES), the controller 82B moves to Step S58 in order to determine whether the uncorrectable error is detected. When the signal amplitude value of the multiplexed signal after digital conversion does not exceed the fourth amplitude threshold (Step S60: NO), the controller 82B terminates processing operations illustrated in FIG. 8. Moreover, when the main light signal is not received (Step S51: NO), the controller 82B terminates processing operations illustrated in FIG. 8.

When the signal amplitude value of the multiplexed signal after digital conversion is less than the third amplitude threshold and the output power of local light is not the maximum, the controller 82B that performs the third local light control process illustrated in FIG. 8 increases the output power of local light. As a result, the stable signal quality of the main light signal can be secured by causing the output power of the main light signal to fall within the signal quality margin.

When the signal amplitude value of the multiplexed signal after digital conversion exceeds the fourth amplitude threshold and the output power of local light is not the minimum, the controller 82B decreases the output power of local light. As a result, by causing the output power of the main light signal to fall within the signal quality margin, it is possible to suppress wasteful power consumption used for local light while securing the stable signal quality of the main light signal.

The receiving device 1B according to the third embodiment controls the driving circuit 21 in order to adjust the output power of local light on the basis of the signal amplitude value of the multiplexed signal after digital conversion acquired by the third monitoring unit 84. For example, when the signal amplitude value of the multiplexed signal after digital conversion exceeds the fourth amplitude threshold, the receiving device 1B controls the driving circuit 21 in order to decrease the output power of local light. As a result, it is possible to suppress wasteful power consumption used for local light while securing the stable signal quality of the main light signal. Furthermore, because the output power of local light is controlled finally by using amplitude information after digital conversion, errors in internal processing are hard to occur.

It has been explained that the receiving device 1B of the third embodiment controls the output power of local light on the basis of the signal amplitude value of the multiplexed signal after digital conversion. However, the receiving device 1B may control the output power of local light based on the signal amplitude value of the multiplexed signal after digital conversion together with the control of the output power of local light based on the number of correction bits and/or the error rate associated with the receiving device 1 according to the first embodiment. In other words, because the output power of local light is previously adjusted by using the signal amplitude value of the multiplexed signal after digital conversion, the adjustment process of the output power of local light can be speedily performed by using the subsequent number of correction bits and/or error rate.

When the control of the output power of local light based on the number of correction bits and/or the error rate is used together, the receiving device 1B may predict the output power of local light from the signal amplitude value of the multiplexed signal after digital conversion. In this case, the receiving device 1B controls the driving circuit 21 in order to adjust the output power of local light on the basis of the prediction result and the number of correction bits and/or the error rate. As a result, the adjustment process of the output power of local light can be speedily performed by using the number of correction bits and/or the error rate.

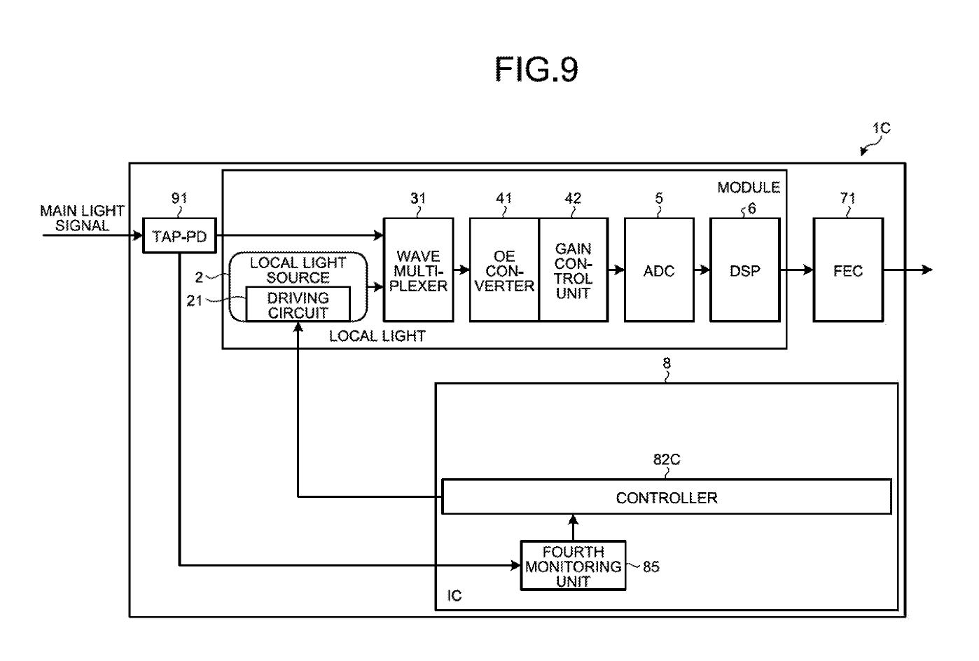

It has been explained that the receiving device 1 of the first embodiment controls the output power of local light on the basis of the number of correction bits and/or the error rate. However, the embodiment is not limited to the number of correction bits and/or the error rate. For example, the output power of local light may be controlled by using the output power of a received main light signal. An embodiment for this case will be explained below as a fourth embodiment. FIG. 9 is a diagram explaining a functional configuration example of a receiving device 1C according to the fourth embodiment. Moreover, because the same components as those of the receiving device 1 of the first embodiment have the same reference numbers, the explanations of the same configuration and operation are omitted.

### [d] Fourth Embodiment

A difference between the receiving device 1C illustrated in FIG. 9 and the receiving device 1 illustrated in FIG. 1 is a point that the receiving device 1C includes TAP-PD 91 and a fourth monitoring unit 85 instead of the first monitoring unit 81. The TAP-PD 91 is placed in the previous stage of the wave multiplexer 31. When receiving a main light signal, the main light signal is transmitted to the wave multiplexer 31 and the fourth monitoring unit 85 by branching by the TAP-PD 91. The fourth monitoring unit 85 acquires the output power of the main light signal branched at the TAP-PD 91. A controller 82C adjusts the output power of local light on the basis of a monitoring result of the fourth monitoring unit 85.

The controller 82C totalizes the output power of the received main light signal and the output power of local light. When the totalized value is less than a first totalized threshold and the output power of local light is not the maximum, the controller 82C adjusts the output power of local light in an increasing direction. Moreover, the first totalized threshold is the minimum signal amplitude value of an allowable range in which the main light signal can secure stable signal quality.

When the totalized value exceeds a second totalized threshold and the output power of local light is not the minimum, the controller 82C adjusts the output power of local light in a decreasing direction. Moreover, the second totalized threshold is the maximum signal amplitude value of the allowable range in which the main light signal can secure stable signal quality.

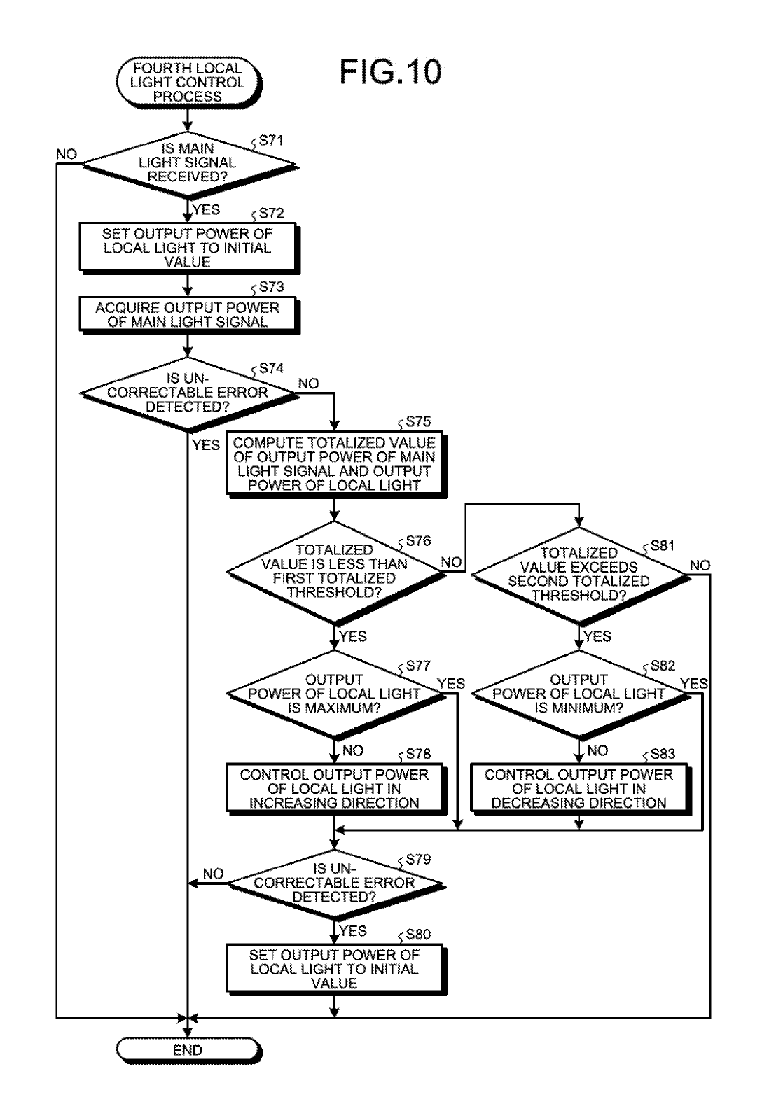

Next, operations of the receiving device 1C according to the fourth embodiment will be explained. FIG. 10 is a flowchart illustrating an example of processing operations of the controller 82C in the receiving device 1C that are associated with a fourth local light control process.

The controller 82C determines whether a main light signal is received (Step S71). When the main light signal is received (Step S71: YES), the controller 82C controls the driving circuit 21 of the local light source 2 in order to set the output power of local light to an initial value (Step S72).

The controller 82C acquires the output power of the main light signal from the TAP-PD 91 via the fourth monitoring unit 85 (Step S73). The controller 82C determines whether an uncorrectable error from the FEC 71 is detected (Step S74). When the uncorrectable error is detected (Step S74: YES), the controller 82C terminates processing operations illustrated in FIG. 10.

When the uncorrectable error is not detected (Step S74: NO), the controller 82C computes a totalized value of the output power of the main light signal acquired in Step S73 and the output power of local light (Step S75). The controller 82C determines whether the totalized value is less than the first totalized threshold (Step S76). When the totalized value is less than the first totalized threshold (Step S76: YES), the controller 82C determines whether the output power of local light is the maximum (Step S77).

When the output power of local light is not the maximum (Step S77: NO), the controller 82C controls the driving circuit 21 of the local light source 2 in order to increase the output power of local light (Step S78). In other words, the output power of the main light signal falls within the signal quality margin by increasing the output power of local light. As a result, the stable signal quality of the main light signal can be improved. After controlling the driving circuit 21 of the local light source 2, the controller 82C determines whether the uncorrectable error is detected (Step S79).

When the uncorrectable error is detected (Step S79: YES), the controller 82C controls the driving circuit 21 of the local light source 2 in order to set the output power of local light to the initial value (Step S80), and terminates processing operations illustrated in FIG. 10. When the uncorrectable error is not detected (Step S79: NO), the controller 82C terminates processing operations illustrated in FIG. 10. When the output power of local light is the maximum (Step S77: YES), the controller 82C moves to Step S79 in order to determine whether the uncorrectable error is detected.

When the totalized value is not less than the first totalized threshold (Step S76: NO), the controller 82C determines whether the totalized value exceeds the second totalized threshold (Step S81). When the totalized value exceeds the second totalized threshold (Step S81: YES), the controller 82C determines whether the output power of local light is the minimum (Step S82).

When the output power of local light is not the minimum (Step S82: NO), the controller 82C controls the driving circuit 21 of the local light source 2 in order to decrease the output power of local light (Step S83). In other words, the output power of the main light signal falls within the signal quality margin by decreasing the output power of local light. As a result, it is possible to suppress wasteful power consumption used for local light while securing the stable signal quality of the main light signal. After controlling the driving circuit 21 of the local light source 2, the controller 82C moves to Step S79 in order to determine whether the uncorrectable error is detected.

When the output power of local light is the minimum (Step S82: YES), the controller 82C moves to Step S79 in order to determine whether the uncorrectable error is detected. When the totalized value does not exceed the second totalized threshold (Step S81: NO), the controller 82C terminates processing operations illustrated in FIG. 10. Moreover, when the main light signal is not received (Step S71: NO), the controller 82C terminates processing operations illustrated in FIG. 10.

When the totalized value obtained by totalizing the output power of the main light signal and the output power of local light is less than the first totalized threshold and the output power of local light is not the maximum, the controller 82C that performs the fourth local light control process illustrated in FIG. 10 increases the output power of local light. As a result, the stable signal quality of the main light signal can be secured by causing the output power of the main light signal to fall within the signal quality margin.

When the totalized value obtained by totalizing the output power of the main light signal and the output power of local light exceeds the second totalized threshold and the output power of local light is not the minimum, the controller 82C decreases the output power of local light. As a result, by causing the output power of the main light signal to fall within the signal quality margin, it is possible to suppress wasteful power consumption used for local light while securing the stable signal quality of the main light signal.

The receiving device 1C according to the fourth embodiment controls the driving circuit 21 in order to adjust the output power of local light on the basis of the totalized value of the output power of the main light signal acquired by the fourth monitoring unit 85 and the output power of local light. For example, when the totalized value exceeds the second totalized threshold, the receiving device 1C controls the driving circuit 21 in order to decrease the output power of local light. As a result, it is possible to suppress wasteful power consumption used for local light while securing the stable signal quality of the main light signal.

It has been explained that the receiving device 1C of the fourth embodiment controls the output power of local light on the basis of the totalized value obtained by totalizing the output power of the main light signal and the output power of local light. However, the receiving device 1C may control the output power of local light based on the totalized value together with the control of the output power of local light based on the number of correction bits and/or the error rate associated with the receiving device 1 according to the first embodiment. In other words, because the output power of local light is previously adjusted by using the totalized value, the adjustment process of the output power of local light can be speedily performed by using the subsequent number of correction bits and/or error rate.

When the control of the output power of local light based on the number of correction bits and/or the error rate is used together, the receiving device 1C may predict the output power of local light from the totalized value of the output power of the main light signal and the output power of local light. In this case, the receiving device 1C controls the driving circuit 21 in order to adjust the output power of local light on the basis of the prediction result and the number of correction bits and/or the error rate. As a result, the adjustment process of the output power of local light can be speedily performed by using the number of correction bits and/or the error rate.

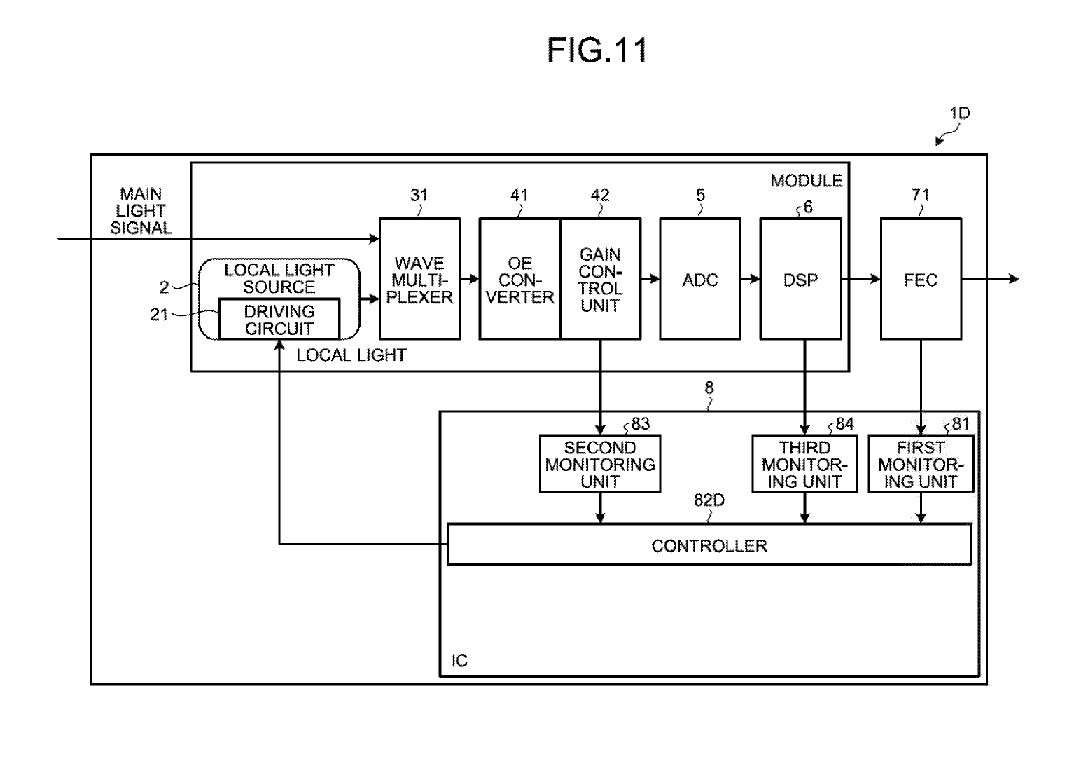

It has been explained that the receiving device 1 of the first embodiment controls the output power of local light on the basis of the number of correction bits and/or the error rate. However, the embodiment is not limited to the number of correction bits and/or the error rate. For example, the output power of local light may be controlled by using signal amplitude values of multiplexed signals before and after digital conversion. An embodiment for this case will be explained below as a fifth embodiment. FIG. 11 is a diagram explaining a functional configuration example of a receiving device 1D according to the fifth embodiment. Moreover, because the same components as those of the receiving device 1 of the first embodiment have the same reference numbers, the explanations of the same configuration and operation are omitted.

### [e] Fifth Embodiment

A difference between the receiving device 1D illustrated in FIG. 11 and the receiving device 1 is a point that the receiving device 1D embeds therein, in addition to the first monitoring unit 81, the second monitoring unit 83 that acquires a signal amplitude value of a multiplexed signal before digital conversion and the third monitoring unit 84 that acquires a signal amplitude value of a multiplexed signal after digital conversion. Furthermore, when the signal amplitude value of the multiplexed signal before digital conversion acquired by the second monitoring unit 83 exceeds the second amplitude threshold and the output power of local light is not the minimum, a controller 82D adjusts the output power of local light in a decreasing direction. Moreover, the second amplitude threshold is the maximum signal amplitude value of an allowable range in which a main light signal can secure stable signal quality.

When the signal amplitude value of the multiplexed signal after digital conversion acquired by the third monitoring unit 84 is less than the third amplitude threshold and the output power of local light is not the maximum, the controller 82D adjusts the output power of local light in an increasing direction. Moreover, the third amplitude threshold is the minimum signal amplitude value of the allowable range in which the main light signal can secure stable signal quality.

When the number of correction bits and/or the error rate acquired by the first monitoring unit 81 exceed(s) the first threshold α1 and the output power of local light is not the maximum, the controller 82D adjusts the output power of local light in an increasing direction. Furthermore, when the acquired number of correction bits and/or error rate are(is) less than the second threshold α2 and the output power of local light is not the minimum, the controller 82D adjusts the output power of local light in a decreasing direction.

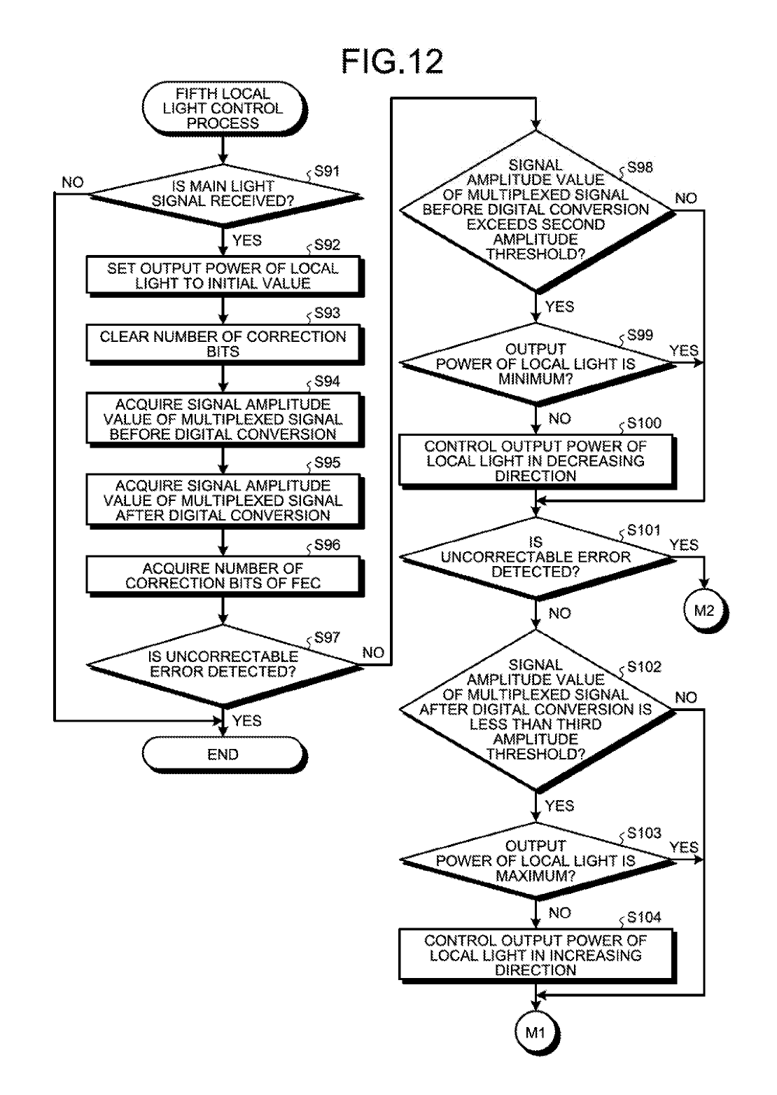

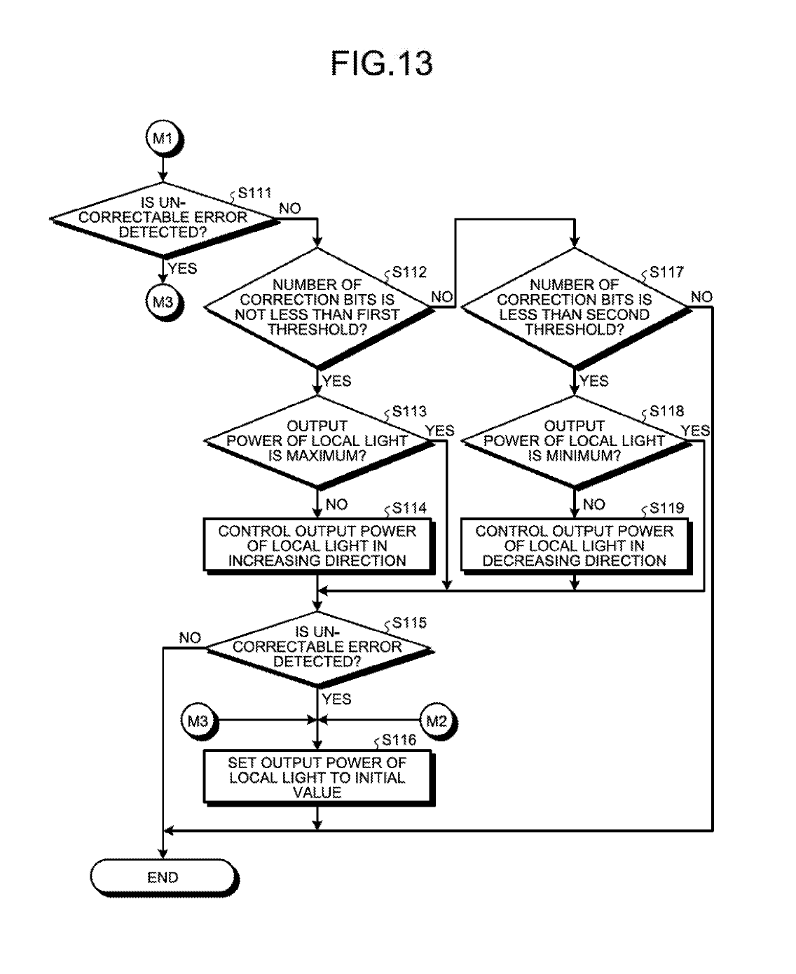

Next, operations of the receiving device 1D according to the fifth embodiment will be explained. FIGS. 12 and 13 are flowcharts illustrating an example of processing operations of the controller 82D in the receiving device 1D that are associated with a fifth local light control process.

In FIG. 12, the controller 82D determines whether a main light signal is received (Step S91). When the main light signal is received (Step S91: YES), the controller 82D controls the driving circuit 21 of the local light source 2 in order to set the output power of local light to an initial value (Step S92).

The controller 82D clears the number of correction bits and/or the error rate (Step S93), and acquires a signal amplitude value of a multiplexed signal before digital conversion from the gain control unit 42 via the second monitoring unit 83 (Step S94). Furthermore, the controller 82D acquires a signal amplitude value of a multiplexed signal after digital conversion from the DSP 6 via the third monitoring unit 84 (Step S95). The controller 82D acquires the number of correction bits and/or the error rate from the FEC 71 via the first monitoring unit 81 (Step S96).

The controller 82D determines whether an uncorrectable error is detected from the FEC 71 (Step S97). When the uncorrectable error is detected (Step S97: YES), the controller 82D terminates processing operations illustrated in FIG. 12.

When the uncorrectable error is not detected (Step S97: NO), the controller 82D determines whether the signal amplitude value of the multiplexed signal before digital conversion acquired in Step S94 exceeds the second amplitude threshold (Step S98). When the signal amplitude value exceeds the second amplitude threshold (Step S98: YES), the controller 82D determines whether the output power of local light is the minimum (Step S99).

When the output power of local light is not the minimum (Step S99: NO), the controller 82D controls the driving circuit 21 of the local light source 2 in order to decrease the output power of local light (Step S100). In other words, the output power of the main light signal falls within the signal quality margin by decreasing the output power of local light. As a result, it is possible to suppress wasteful power consumption used for local light while securing the stable signal quality of the main light signal. After controlling the driving circuit 21 of the local light source 2, the controller 82D determines whether the uncorrectable error is detected (Step S101).

When the uncorrectable error is not detected (Step S101: NO), the controller 82D determines whether the signal amplitude value of the multiplexed signal after digital conversion acquired in Step S95 is less than the third amplitude threshold (Step S102). When the signal amplitude value of the multiplexed signal after digital conversion is less than the third amplitude threshold (Step S102: YES), the controller 82D determines whether the output power of local light is the maximum (Step S103).

When the output power of local light is not the maximum (Step S103: NO), the controller 82D controls the driving circuit 21 of the local light source 2 in order to increase the output power of local light (Step S104), and moves to M1 illustrated in FIG. 13. In other words, the output power of the main light signal falls within the signal quality margin by increasing the output power of local light. As a result, the stable signal quality of the main light signal can be improved.

When the signal amplitude value of the multiplexed signal before digital conversion does not exceed the second amplitude threshold (Step S98: NO), the controller 82D moves to Step S101 in order to determine whether the uncorrectable error is detected. Moreover, when the output power of local light is the minimum (Step S99: YES), the controller 82D moves to Step S101 in order to determine whether the uncorrectable error is detected.

When the signal amplitude value of the multiplexed signal after digital conversion is not less than the third amplitude threshold (Step S102: NO) or when the output power of local light is the maximum (Step S103: YES), the controller 82D moves to M1 illustrated in FIG. 13. When the uncorrectable error is detected (Step S101: YES), the controller 82D moves to M2 illustrated in FIG. 13. Moreover, when the main light signal is not received (Step S91: NO), the controller 82D terminates processing operations illustrated in FIG. 12.

In M1 illustrated in FIG. 13, the controller 82D determines whether the uncorrectable error is detected from the FEC 71 (Step S111). When the uncorrectable error is not detected (Step S111: NO), the controller 82D determines whether the number of correction bits and/or the error rate exceeds the first threshold α1 (Step S112). When the number of correction bits and/or the error rate exceeds the first threshold α1 (Step S112: YES), the controller 82D determines whether the output power of local light is the maximum (Step S113).

When the output power of local light is not the maximum (Step S113: NO), the controller 82D controls the driving circuit 21 of the local light source 2 in order to increase the output power of local light (Step S114). In other words, the output power of the main light signal falls within the signal quality margin by increasing the output power of local light. As a result, the stable signal quality of the main light signal can be improved. After controlling the driving circuit 21 of the local light source 2, the controller 82D determines whether the uncorrectable error is detected (Step S115).

When the uncorrectable error is detected (Step S115: YES), the controller 82D controls the driving circuit 21 of the local light source 2 in order to set the output power of local light to the initial value (Step S116), and terminates processing operations illustrated in FIG. 13. When the uncorrectable error is not detected (Step S115: NO), the controller 82D terminates processing operations illustrated in FIG. 13. When the output power of local light is the maximum (Step S113: YES), the controller 82D moves to Step S115 in order to determine whether the uncorrectable error is detected.

When the number of correction bits and/or the error rate do(does) not exceed the first threshold α1 (Step S112: NO), the controller 82D determines whether the number of correction bits and/or the error rate are(is) less than the second threshold α2 (Step S117). When the number of correction bits and/or the error rate are(is) less than the second threshold α2 (Step S117: YES), the controller 82D determines whether the output power of local light is the minimum (Step S118).

When the output power of local light is not the minimum (Step S118: NO), the controller 82D controls the driving circuit 21 of the local light source 2 in order to decrease the output power of local light (Step S119). In other words, the output power of the main light signal falls within the signal quality margin by decreasing the output power of local light. As a result, it is possible to suppress wasteful power consumption used for local light while securing the stable signal quality of the main light signal. After controlling the driving circuit 21 of the local light source 2, the controller 82D moves to Step S115 in order to determine whether the uncorrectable error is detected.

When the output power of local light is the minimum (Step S118: YES), the controller 82D moves to Step S115 in order to determine whether the uncorrectable error is detected. When the number of correction bits and/or the error rate are(is) not less than the second threshold α2 (Step S117: NO), the controller 82D terminates processing operations illustrated in FIG. 13.

In M2 illustrated in FIG. 13, the controller 82D moves to Step S116 in order to set the output power of local light to the initial value. When the uncorrectable error is detected (Step S111: YES), the controller 82D moves to M3 illustrated in FIG. 13, namely, Step S116 in order to set the local light to the initial value.

When the signal amplitude value of the multiplexed signal before digital conversion exceeds the second amplitude threshold and the output power of local light is not the minimum, the controller 82D that performs the fifth local light control process decreases the output power of local light. As a result, by causing the output power of the main light signal to fall within the signal quality margin, it is possible to suppress wasteful power consumption used for local light while securing the stable signal quality of the main light signal.

When the signal amplitude value of the multiplexed signal after digital conversion is less than the third amplitude threshold and the output power of local light is not the maximum, the controller 82D increases the output power of local light. As a result, the stable signal quality of the main light signal can be secured by causing the output power of the main light signal to fall within the signal quality margin.

When the number of correction bits and/or the error rate exceed(s) the first threshold α1 and the output power of local light is not the maximum, the controller 82D increases the output power of local light. As a result, the stable signal quality of the main light signal can be secured by causing the output power of the main light signal to fall within the signal quality margin.

When the number of correction bits and/or the error rate are(is) less than the second threshold α2 and the output power of local light is not the minimum, the controller 82D decreases the output power of local light. As a result, by causing the output power of the main light signal to fall within the signal quality margin, it is possible to suppress wasteful power consumption used for local light while securing the stable signal quality of the main light signal.

When the signal amplitude value of the multiplexed signal before digital conversion exceeds the second amplitude threshold and the output power of local light is not the minimum, the receiving device 1D according to the fifth embodiment decreases the output power of local light. As a result, it is possible to suppress wasteful power consumption used for local light while securing the stable signal quality of the main light signal.

When the signal amplitude value of the multiplexed signal after digital conversion is less than the third amplitude threshold and the output power of local light is not the maximum, the controller 82D increases the output power of local light. As a result, the stable signal quality of the main light signal can be secured.

When the number of correction bits and/or the error rate exceed(s) the first threshold α1 and the output power of local light is not the maximum, the controller 82D increases the output power of local light. As a result, the stable signal quality of the main light signal can be secured.

When the number of correction bits and/or the error rate are(is) less than the second threshold α2 and the output power of local light is not the minimum, the controller 82D decreases the output power of local light. As a result, it is possible to suppress wasteful power consumption used for local light while securing the stable signal quality of the main light signal. Also, the FEC 71 may be involved in the DSP 6.

Components of each device illustrated in the drawings are not necessarily constituted physically as illustrated in the drawings. In other words, the specific configuration of dispersion/integration of each device is not limited to the illustrated configuration. Therefore, all or a part of each device can dispersed or integrated functionally or physically in an optional unit in accordance with various types of loads or operating conditions.

All or a part of the process functions performed by each device may be realized by a CPU (Central Processing Unit) (or microcomputer such as MPU (Micro Processing Unit) or MCU (Micro Controller Unit)) and a program that is analyzed and executed by the CPU (or microcomputer such as MPU or MCU), or may be realized by a hardware by wired logic.

According to an aspect of embodiments, it is possible to suppress power consumption used for local light.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A receiving device comprising:
a light source that outputs local light;
a wave multiplexer that causes the local light to interfere with a received signal to acquire an optical signal;
a converter that converts the optical signal into an electrical signal; and
a demodulator that demodulates the electrical signal to acquire a demodulated signal;
a processor configured to:
correct an error of the demodulated signal;
acquire a signal correction amount and/or an error rate; and
control the light source in order to adjust an output intensity of the local light based on the signal correction amount and/or the error rate.

2. The receiving device according to claim 1, wherein the processor is further configured to control the light source in order to decrease the output intensity of the local light when the signal correction amount and/or the error rate are/is less than a predetermined threshold.

3. The receiving device according to claim 1, wherein the processor is further configured to:
acquire a signal amplitude value of the electrical signal from the converter; and
control the light source in order to adjust the output intensity of the local light based on the signal amplitude value of the electrical signal.

4. The receiving device according to claim 1, wherein the processor is further configured to:
acquire a signal amplitude value of the demodulated signal from the demodulator; and
control the light source in order to adjust the output intensity of the local light based on the signal amplitude value of the demodulated signal.

5. The receiving device according to claim 1, wherein the processor is further configured to:
acquire an output intensity of the received signal; and
control the light source in order to adjust the output intensity of the local light based on a totalized value of the output intensity of the received signal and the output intensity of the local light.

6. The receiving device according to claim 1, wherein the processor is further configured to:
acquire a signal amplitude value of the electrical signal from the converter;
predict the output intensity of the local light based on the signal amplitude value of the electrical signal; and
control the light source in order to adjust the output intensity of the local light based on a prediction result and the signal correction amount and/or the error rate.

7. The receiving device according to claim 1, wherein the processor is further configured to:
acquire a signal amplitude value of the demodulated signal from the demodulator;
predict the output intensity of the local light based on the signal amplitude value of the demodulated signal; and
control the light source in order to adjust the output intensity of the local light based on a prediction result and the signal correction amount and/or the error rate.

8. The receiving device according to claim 1, wherein the processor is further configured to:
acquire an output intensity of the received signal;
predict the output intensity of the local light based on a totalized value of the output intensity of the received signal and the output intensity of the local light; and
control the light source in order to adjust the output intensity of the local light based on a prediction result and the signal correction amount and/or the error rate.

9. A local light control method for a receiving device, the local light control method comprising:
causing, by a processor of the receiving device, local light to interfere with a received signal to acquire an optical signal;
converting, by the processor, the optical signal into an electrical signal;
demodulating, by the processor, the electrical signal to acquire a demodulated signal;
correcting, by the processor, an error of the demodulated signal;
acquiring, by the processor, a signal correction amount and/or an error rate during correcting the error; and
adjusting, by the processor, an output intensity of the local light based on the signal correction amount and/or the error rate.
